(19) United States
(12) Patent Application Publication
(10) Pub. No.: US 2009/0285350 A1
(43) Pub. Date: Nov. 19, 2009

(54) Multi-layer fuel channel and method of fabricating the same

(75) Inventors: Paul Everett Cantonwine, Wilmington, NC (US); David William White, Wilmington, NC (US)

Correspondence Address: HARNESS, DICKEY & PIERCE, P.L.C., P.O. BOX 8910, RESTON, VA, 20195, US

(73) Assignee: Global Nuclear Fuel-Americas, LLC

(21) Appl. No.: 12/153,415

(22) Filed: May 19, 2008

(51) Int. Cl. G21C 3/06; B32B 15/04; B21C 37/08; C22F 1/18; B23K 15/06; B32B 33/00

(52) U.S. Cl. 376/412; 428/615; 428/660; 29/458; 219/121.13; 148/672

(57) ABSTRACT

A fuel channel according to example embodiments for a nuclear reactor may have an elongated and hollow body with a multi-layer structure. The multi-layer structure may include a core layer and at least one cladding layer metallurgically-bonded to the core layer. The core layer and the at least one cladding layer may be alloys having different compositions. For instance, the core layer may be significantly more resistant to irradiation growth and/or irradiation creep than the at least one cladding layer, and the at least one cladding layer may have an increased resistance to hydrogen absorption and/or corrosion relative to the core layer. Accordingly, the distortion of the fuel channel may be reduced or prevented, thus reducing or preventing the interference with the movement of the control blade.

### BACKGROUND

1. Technical Field

The present disclosure relates to fuel channels for use in nuclear reactor cores and methods of fabricating the same.

2. Description of Related Art

A conventional boiling water reactor (BWR) has a plurality of cells in the reactor core. Each cell has four fuel channels, and each fuel channel contains a plurality of fuel rods. A fuel channel and the fuel rods within constitute a fuel assembly. A conventional fuel channel is a hollow box with an elongated body. The channel sides have either uniform thickness or contours with thick and thin dimensions. Additionally, a conventional fuel channel is formed of a single alloy.

A control blade is cruciform-shaped and movably-positioned between the adjacent surfaces of the fuel channels in a cell for purposes of controlling the reaction rate of the reactor core. There is one control blade per cell. As a result, each fuel channel has two sides adjacent to the control blade and two sides with no adjacent control blade. The control blade is formed of a material that is capable of absorbing neutrons without undergoing fission itself. For instance, the composition of a control blade includes boron, hafnium, silver, indium, cadmium, or other elements having a sufficiently high capture cross section for neutrons. Thus, when the control blade is moved between the adjacent surfaces of the fuel channels, the control blade absorbs neutrons which would otherwise contribute to the fission reaction in the core. On the other hand, when the control blade is moved out of the way, more neutrons will be allowed to contribute to the fission reaction in the core.

However, after a period of time, a fuel channel will become distorted as a result of differential irradiation growth, differential hydrogen absorption, and/or irradiation creep. Differential irradiation growth is caused by fluence gradients and results in fluence-gradient bow. Differential hydrogen absorption is a function of differential corrosion resulting from shadow corrosion on the channels sides adjacent to the control blades and the percent of hydrogen liberated from the corrosion process that is absorbed into the fuel channel; this results in shadow corrosion-induced bow. Irradiation creep is caused by a pressure drop across the channel faces, which results in creep bulge. As a result, the distortion (e.g., bowing) of the fuel channel may interfere with the movement of the control blade. Channel/control blade interference may cause uncertainty in control blade location, increased loads on reactor structural components, and decreased scram velocities. If channel/control blade interference is severe, the control blade is declared inoperable and remains fully inserted, thus decreasing the power output of the reactor plant.

### SUMMARY

Example embodiments of the present disclosure relate to a multi-layer material for a reactor component, a fuel channel formed of the multi-layer material, and a method of fabricating the fuel channel.

A multi-layer material according to example embodiments for a reactor component may include a core layer and at least one cladding layer metallurgically-bonded to the core layer. The core layer and the at least one cladding layer may be alloys having different compositions that provide different functions. For instance, the core layer may be significantly more resistant to irradiation growth and/or irradiation creep than the at least one cladding layer, and the at least one cladding layer may have an increased resistance to hydrogen absorption and/or corrosion relative to the core layer.

A fuel channel according to example embodiments for a nuclear reactor may have an elongated and hollow body with a multi-layer structure. The multi-layer structure may include a core layer and at least one cladding layer metallurgically-bonded to the core layer. The core layer and the at least one cladding layer may be alloys having different compositions that provide different functions. For instance, the core layer may be significantly more resistant to irradiation growth and/or irradiation creep than the at least one cladding layer, and the at least one cladding layer may have an increased resistance to hydrogen absorption and/or corrosion relative to the core layer.

A method according to example embodiments of fabricating a fuel channel for a nuclear reactor may include joining a core material with a cladding material. The core material and the cladding material may be alloys having different compositions that provide different functions. For instance, the core material may be significantly more resistant to irradiation growth and/or irradiation creep than the cladding material, and the cladding material may have an increased resistance to hydrogen absorption and/or corrosion relative to the core material. The joined core and cladding materials may be rolled, and the rolled core and cladding materials may be deformed to form the fuel channel.

### BRIEF DESCRIPTION OF THE DRAWINGS

The features and advantages of example embodiments may become more apparent upon review of the detailed description in conjunction with the accompanying drawings. The accompanying drawings are intended to depict example embodiments and should not be interpreted to limit the intended scope of the claims. The accompanying drawings are not to be considered as drawn to scale unless explicitly noted. For purposes of clarity, various dimensions of the drawings may have been exaggerated.

FIG. 1 is a cross-sectional view of a multi-layer material according to example embodiments of the present disclosure.

FIG. 2 is a cross-sectional view of another multi-layer material according to example embodiments of the present disclosure.

FIG. 3 is a perspective view of a fuel channel according to example embodiments of the present disclosure.

FIG. 4 is a perspective view of another fuel channel according to example embodiments of the present disclosure.

FIG. 5 is a perspective view of a contoured fuel channel according to example embodiments of the present disclosure.

FIG. 6 is a perspective view of another contoured fuel channel according to example embodiments of the present disclosure.

FIG. 7 is a flowchart of a method of fabricating a channel strip for a fuel channel according to example embodiments of the present disclosure.

FIG. 8 is a flowchart of another method of fabricating a channel strip for a fuel channel according to example embodiments of the present disclosure.

FIG. 9 is a flowchart of another method of fabricating a channel strip for a fuel channel according to example embodiments of the present disclosure.

### DETAILED DESCRIPTION

It should be understood that when an element or layer is referred to as being “on”, “connected to”, “coupled to”, or “covering” another element or layer, it may be directly on, connected to, coupled to, or covering the other element or layer or intervening elements or layers may be present. In contrast, when an element is referred to as being “directly on”, “directly connected to”, or “directly coupled to” another element or layer, there are no intervening elements or layers present. Like numbers refer to like elements throughout the specification. As used herein, the term “and/or” includes any and all combinations of one or more of the associated listed items.

It should be understood that, although the terms first, second, third, etc. may be used herein to describe various elements, components, regions, layers and/or sections, these elements, components, regions, layers, and/or sections should not be limited by these terms. These terms are only used to distinguish one element, component, region, layer, or section from another region, layer, or section. Thus, a first element, component, region, layer, or section discussed below could be termed a second element, component, region, layer, or section without departing from the teachings of example embodiments.

Spatially relative terms (e.g., “beneath,” “below,” “lower,” “above,” “upper”, and the like) may be used herein for ease of description to describe one element or feature's relationship to another element(s) or feature(s) as illustrated in the figures. It should be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purpose of describing various embodiments only and is not intended to be limiting of example embodiments. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

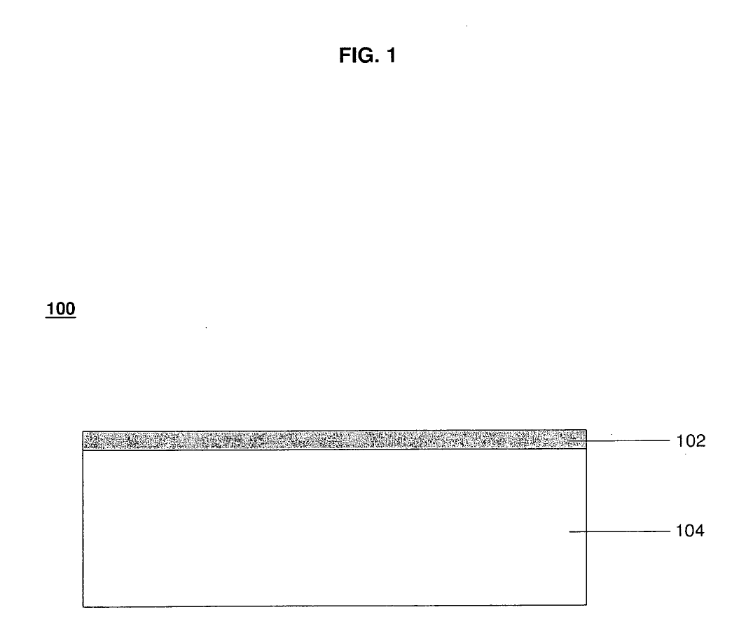

A reactor component according to example embodiments for a boiling water reactor (BWR) may be formed of a composite material having a multi-layer structure. Referring to FIG. 1, the multi-layer structure of a composite material 100 may include a cladding layer 102 disposed on a core layer 104. The core layer 104 may be formed of a first alloy, and the cladding layer 102 may be formed of a second alloy. The first and second alloys may have different compositions. Additionally, the cladding layer 102 may be metallurgically-bonded to the core layer 104. Furthermore, the core layer 104 and the cladding layer 102 may have different physical properties (e.g., resistance to irradiation growth, hydrogen absorption, corrosion, and/or irradiation creep).

Accordingly, the core layer 104 and the cladding layer 102 may be combined in such a manner so as to achieve a composite material that advantageously exploits the beneficial properties of both the core layer 104 and the cladding layer 102. For instance, the core layer 104 may have a greater resistance to irradiation growth and/or irradiation creep relative to the cladding layer 102, and the cladding layer 102 may have a greater resistance to corrosion and/or hydrogen absorption relative to the core layer 104. It may be beneficial for the core layer 104 to be significantly more resistant to irradiation growth and/or irradiation creep than the cladding layer 102. The core layer 104 may be considered significantly more resistant if it is approximately fifty percent more resistant to irradiation growth and/or irradiation creep than the cladding layer 102. Conversely, it may be beneficial for the cladding layer 102 to be at least about fifty percent more resistant to corrosion and/or hydrogen absorption than the core layer 104. As a result, the core layer 104 may be less prone to fluence-gradient bow and/or creep bulge, while the cladding layer 102 may be less prone to shadow corrosion-induced bow.

The first alloy may be a zirconium (Zr) alloy containing niobium (Nb). For instance, the first alloy may be a NSF alloy. The NSF alloy may have a composition (in weight percent) of about 0.6-1.4% niobium (Nb), about 0.2-0.5% iron (Fe), and about 0.5-1.0% tin (Sn), with the balance being essentially zirconium (Zr). For example, the NSF alloy may have a composition (in weight percent) of about 1.0 % niobium, about 0.35% iron, and about 1.0% tin, with the balance being essentially zirconium.

The second alloy may be a zirconium (Zr) alloy containing tin (Sn), iron (Fe), and chromium (Cr). The second alloy may have a composition (in weight percent) of about 0.4-2.0% tin (Sn), about 0.1-0.6% iron (Fe), and about 0.01-1.2% chromium (Cr), with the balance being essentially zirconium (Zr).

The second alloy may be a Zircaloy-4 alloy. The Zircaloy-4 alloy may have a composition (in weight percent) of about 1.2-1.7% tin (Sn), about 0.12-0.21% iron (Fe), and about 0.05-0.15% chromium (Cr), with the balance being essentially zirconium (Zr). For example, the Zircaloy-4 alloy may have a composition (in weight percent) of about 1.45% tin, about 0.21% iron, and about 0.1% chromium, with the balance being essentially zirconium.

The second alloy may also be a VB alloy. The VB alloy may have a composition (in weight percent) of about 0.4-0.6% tin (Sn), about 0.4-0.6% Fe, and about 0.8-1.2% chromium (Cr), with the balance being essentially zirconium (Zr). For example, the VB alloy may have a composition (in weight percent) of about 0.5% tin, about 0.5% iron, and about 1.0% chromium, with the balance being essentially zirconium.

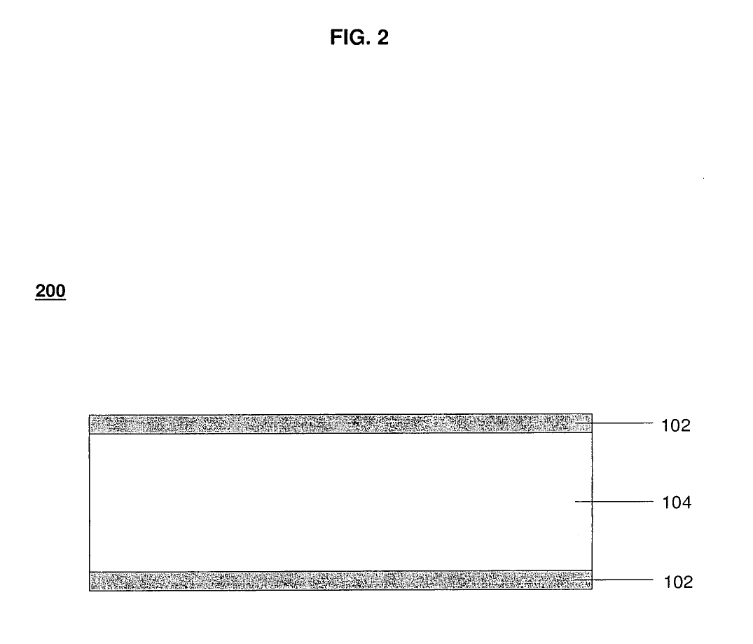

Referring to FIG. 2, the multi-layer structure of another composite material 200 may include a core layer 104 disposed between two cladding layers 102. The core layer 104 may be formed of a first alloy, and the cladding layers 102 may be formed of a second alloy. The first and second alloys may have different compositions. Additionally, the cladding layers 102 may be metallurgically-bonded to the core layer 104. Furthermore, the core layer 104 and the cladding layers 102 may have different physical properties (e.g., resistance to irradiation growth, hydrogen absorption, and/or irradiation creep).

Accordingly, the core layer 104 and the cladding layers 102 may be combined in such a manner so as to achieve a composite material that advantageously exploits the beneficial properties of both the core layer 104 and the cladding layers 102. For instance, the core layer 104 may have a greater resistance to irradiation growth and/or irradiation creep relative to the cladding layers 102, and the cladding layers 102 may have a greater resistance to corrosion and hydrogen absorption relative to the core layer 104. It may be beneficial for the core layer 104 to be significantly more resistant to irradiation growth and/or irradiation creep than the cladding layers 102. The core layer 104 may be considered significantly more resistant if it is approximately fifty percent more resistant to irradiation growth and/or irradiation creep than the cladding layer 102. Conversely, it may be beneficial for the cladding layers 102 to be at least about fifty percent more resistant to corrosion and/or hydrogen absorption than the core layer 104. As a result, the core layer 104 may be less prone to fluence-gradient bow and/or creep bulge, while the cladding layers 102 may be less prone to shadow corrosion-induced bow.

The first alloy may be a zirconium (Zr) alloy containing niobium (Nb). For instance, the first alloy may be a NSF alloy. The NSF alloy may have a composition (in weight percent) of about 0.6-1.4% niobium (Nb), about 0.2-0.5% iron (Fe), and about 0.5-1.0% tin (Sn), with the balance being essentially zirconium (Zr). For example, the NSF alloy may have a composition (in weight percent) of about 1.0% niobium, about 0.35% iron, and about 1.0% tin, with the balance being essentially zirconium.

The second alloy may be a zirconium (Zr) alloy containing tin (Sn), iron (Fe), and chromium (Cr). The second alloy may have a composition (in weight percent) of about 0.4-2.0% tin (Sn), about 0.1-0.6% iron (Fe), and about 0.01-1.2% chromium (Cr), with the balance being essentially zirconium (Zr).

The second alloy may be a Zircaloy-4 alloy. The Zircaloy-4 alloy may have a composition (in weight percent) of about 1.2-1.7% tin (Sn), about 0.12-0.21% iron (Fe), and about 0.05-0.15% chromium (Cr), with the balance being essentially zirconium (Zr). For instance, the Zircaloy-4 alloy may have a composition (in weight percent) of about 1.45% tin, about 0.21% iron, and about 0.1% chromium, with the balance being essentially zirconium.

The second alloy may also be a VB alloy. The VB alloy may have a composition (in weight percent) of about 0.4-0.6% tin (Sn), about 0.4-0.6% Fe, and about 0.8-1.2% chromium (Cr), with the balance being essentially zirconium (Zr). For example, the VB alloy may have a composition (in weight percent) of about 0.5% tin, about 0.5% iron, and about 1.0% chromium, with the balance being essentially zirconium.

Thus, one or more surfaces of the first alloy may be clad with a second alloy. For instance, the first alloy may be clad on one side with one or more second alloy layers. Alternatively, the first alloy may be sandwiched between two or more second alloy layers. Where a plurality of second alloy layers are used, the second alloy layers may have identical or different compositions. The first and second alloys may be zirconium (Zr) alloys. The use of zirconium in nuclear reactor components may be advantageous, because zirconium has a relatively low neutron absorption cross-section and beneficial corrosion resistance in a relatively high pressure/temperature water environment.

The thickness of the first alloy layer may make up a majority of the thickness of the composite material. For example, the thickness of the first alloy layer may be about 50-100 mil (about 0.050-0.100 inches). On the other hand, the second alloy layer may be relatively thin. For example, the thickness of the second alloy layer may be about 3-4 mil (about 0.003-0.004 inches). However, it should be noted that other dimensions are possible depending on the application. The first and second alloy layers may be metallurgically-bonded.

A reactor component according to example embodiments may include a fuel channel for a boiling water reactor. The fuel channel according to example embodiments may reduce or prevent channel distortion caused by differential irradiation growth, differential hydrogen absorption, and/or irradiation creep. The fuel channel may be manufactured with a first alloy that is relatively resistant to differential irradiation growth and/or irradiation creep. As a result, the first alloy may reduce or prevent the occurrence of fluence-gradient bow and/or creep bulge. The first alloy may be clad with a second alloy that is relatively resistant to hydrogen absorption and/or corrosion. As a result, the second alloy may reduce or prevent the occurrence of shadow corrosion-induced bow.

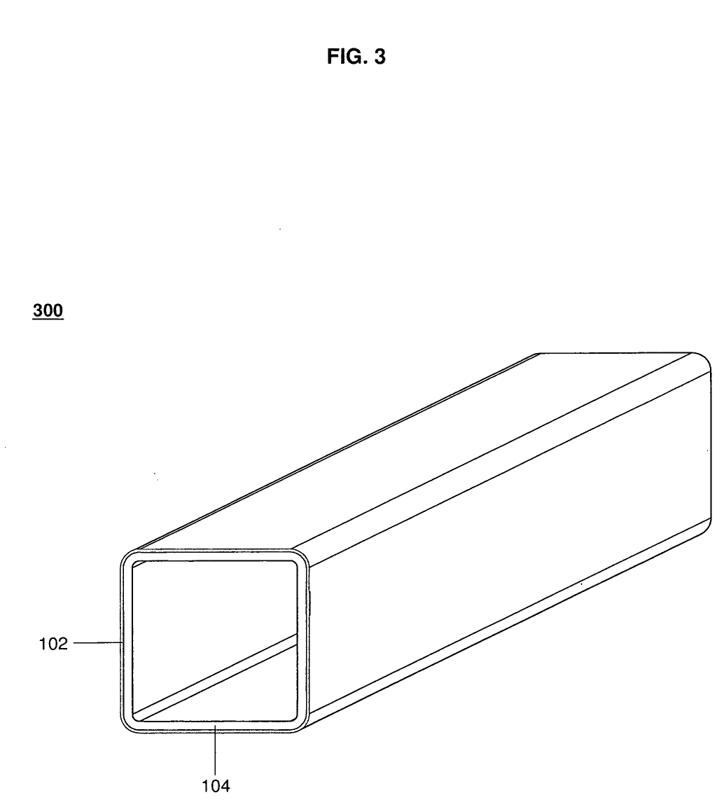

Referring to FIG. 3, a fuel channel 300 may be formed of the material 100 of FIG. 1. Accordingly, the fuel channel 300 may include a cladding layer 102 on the outer surface of the core layer 104. Alternatively, the outer surface of the core layer 104 may be clad with a plurality of cladding layers (not shown).

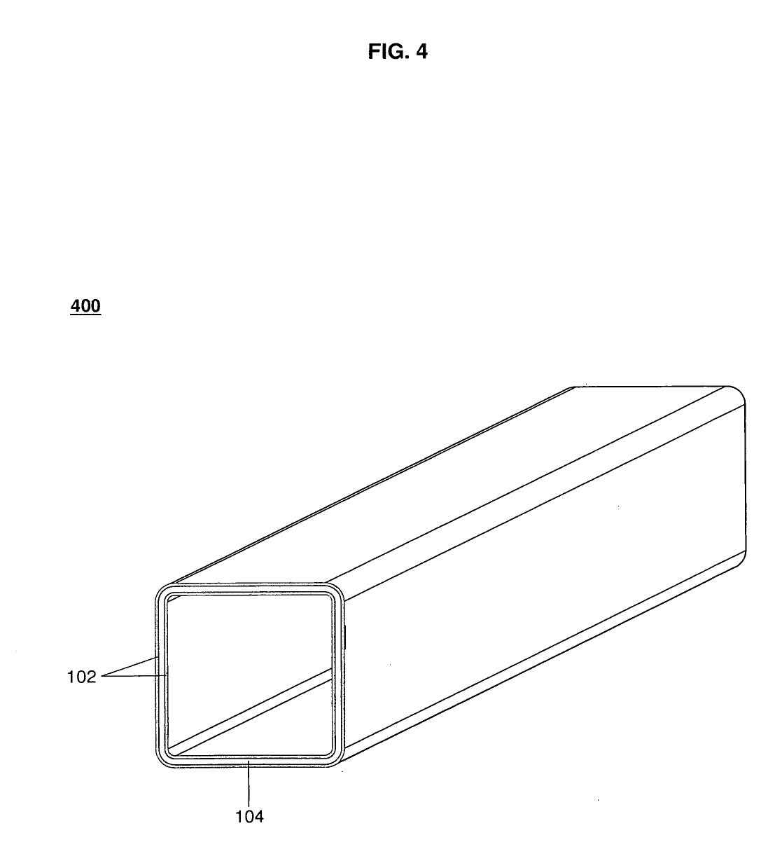

Referring to FIG. 4, a fuel channel 400 may be formed of the material 200 of FIG. 2. Accordingly, the fuel channel 400 may include a cladding layer 102 on the inner surface of the core layer 104 as well as a cladding layer 102 on the outer surface of the core layer 104. Alternatively, the inner and/or outer surfaces of the core layer 104 may be clad with a plurality of cladding layers (not shown).

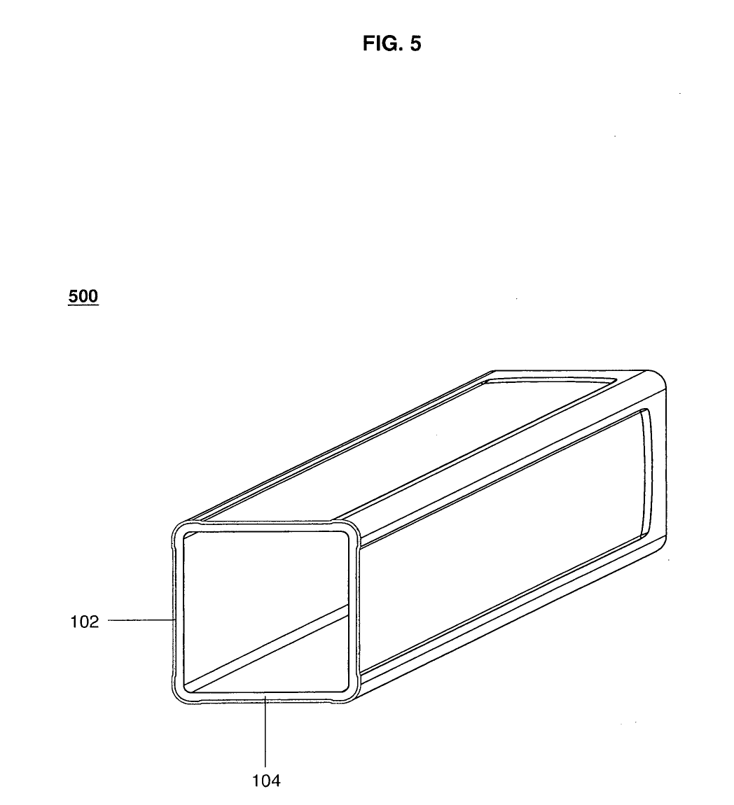

Referring to FIG. 5, a contoured (thick/thin) fuel channel 500 may be formed of the material 100 of FIG. 1. Accordingly, the fuel channel 500 may include a cladding layer 102 on the outer surface of the core layer 104. Alternatively, the outer surface of the core layer 104 may be clad with a plurality of cladding layers (not shown).

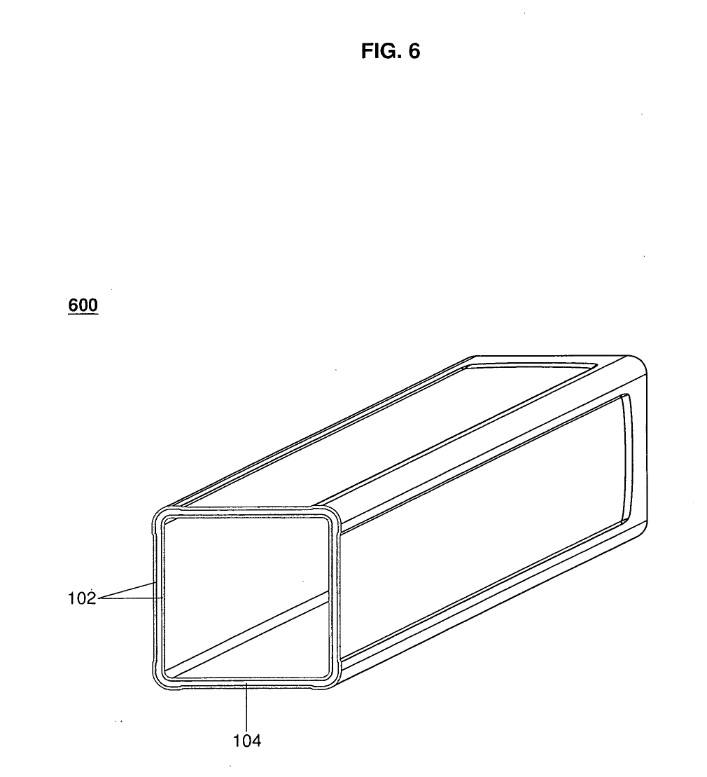

Referring to FIG. 6, a contoured (thick/thin) fuel channel 600 may be formed of the material 200 of FIG. 2. Accordingly, the fuel channel 600 may include a cladding layer 102 on the inner surface of the core layer 104 as well as a cladding layer 102 on the outer surface of the core layer 104. Alternatively, the inner and/or outer surfaces of the core layer 104 may be clad with a plurality of cladding layers (not shown).

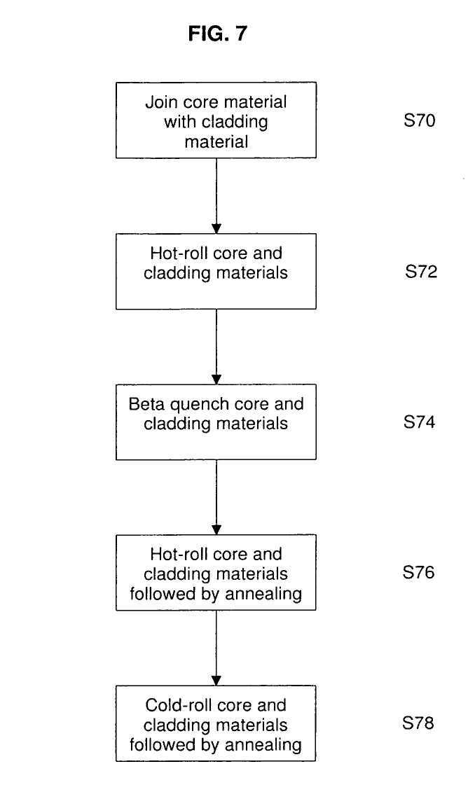

Next, example embodiments of a method for fabricating a fuel channel will be described. FIG. 7 is a flowchart of a method of fabricating a channel strip for a fuel channel according to example embodiments. As shown in step S70, a core material formed of a first alloy is joined to a cladding material formed of a second alloy. For example, a slab formed of a first alloy and a jacket formed of a second alloy may be provided, wherein the first and second alloys may have different compositions. The slab may be an alloy that is relatively resistant to irradiation growth and/or irradiation creep, while the jacket may be an alloy that is relatively resistant to corrosion and/or hydrogen absorption. For instance, the alloys may be as described above with reference to FIGS. 1-2. The slab may be inserted into the jacket, and a vacuum may be drawn to seal the slab in the jacket. Alternatively, it should be noted that the second alloy may also be in the form of a slab which is joined with the slab formed of the first alloy. For instance, the first alloy slab may be electron beam (e-beam) welded to the second alloy slab under a vacuum.

The joined alloy materials may be subjected to a first hot-roll process to achieve a first thickness (e.g., about 1 inch) in step S72. The first hot-roll process may be any well-known hot-roll process. Referring to step S74, the hot-rolled alloy materials may be beta quenched to increase resistance to corrosion. The beta quenching may be achieved with any well-known beta quench process. For example, the hot-rolled alloy materials may be beta heat treated at a temperature greater than about 900 degrees Celsius followed by a beta quench.

Referring to step S76, the quenched alloy materials may also be subjected to a second hot-roll process to achieve a second thickness (e.g., less than 1 inch). The second hot-roll process may be any well-known hot-roll process. The second hot-roll process may be followed by any well-known annealing process (e.g., recrystallization annealing). Referring to step S78, the hot-rolled alloy materials may additionally be subjected to any well-known cold-roll process to achieve a third thickness (e.g., about 0.050-0.110 inches). The cold-roll process may be followed by any well-known annealing process. It may be beneficial for the processing subsequent to the beta quench to be performed at a temperature below about 900 degrees Celsius (e.g., about 500-800 degrees Celsius).

The finished multi-layer material may have a relatively uniform thickness. The finished multi-layer material may be deformed and welded to form a fuel channel. For example, two sheets of the finished material may be bent along the longitudinal direction to approximately 90 degree angles. The bent sheets may then be welded together to form an elongated fuel channel having a square-shaped cross-section.

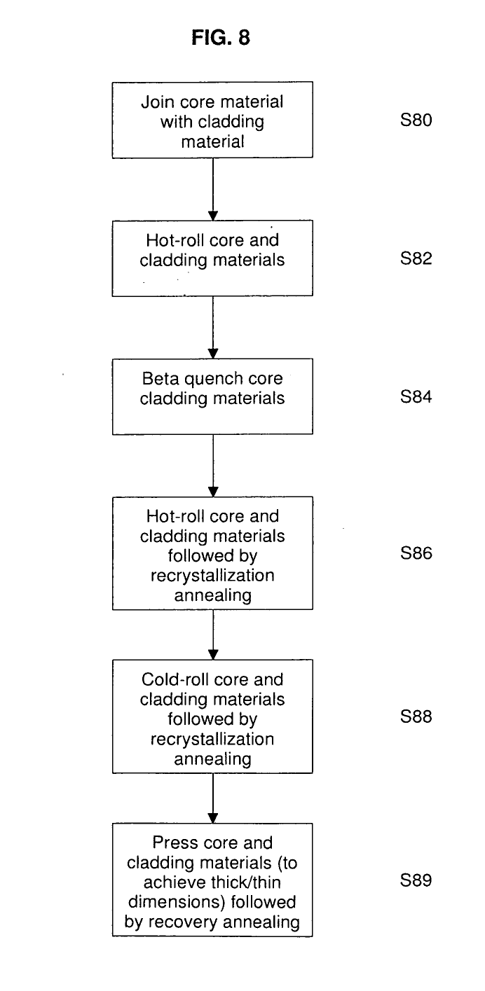

FIG. 8 is a flowchart of another method of fabricating a channel strip for a fuel channel according to example embodiments. As shown in step S80, a core material formed of a first alloy is joined to a cladding material formed of a second alloy. For example, a slab formed of a first alloy and a jacket formed of a second alloy may be provided, wherein the first and second alloys may have different compositions. The slab may be an alloy that is relatively resistant to irradiation growth and/or irradiation creep, while the jacket may be an alloy that is relatively resistant to corrosion and hydrogen absorption. For instance, the alloys may be as described above with regard to FIGS. 1-2. The slab may be inserted into the jacket, and a vacuum may be drawn to seal the slab in the jacket. Alternatively, it should be noted that the second alloy may also be in the form of a slab which is joined with the slab formed of the first alloy. For instance, the first alloy slab may be electron beam (e-beam) welded to the second alloy slab under a vacuum.

The joined alloy materials may be subjected to a first hot-roll process to achieve a first thickness (e.g., about 1 inch) in step S82. The first hot-roll process may be any well-known hot-roll process. Referring to step S84, the hot-rolled alloy materials may be beta quenched to increase resistance to corrosion. The beta quenching may be achieved with any well-known beta quench process. For example, the hot-rolled alloy materials may be beta heat treated at a temperature greater than about 900 degrees Celsius followed by a beta quench.

Referring to step S86, the quenched alloy materials may also be subjected to a second hot-roll process to achieve a second thickness (e.g., less than 1 inch). The second hot-roll process may be any well-known hot-roll process. The second hot-roll process may be followed by any well-known recrystallization (RX) annealing process. Referring to step S88, the hot-rolled alloy materials may be additionally subjected to any well-known cold-roll process to achieve a third thickness (e.g., about 0.060-0.120 inches). The cold-roll process may be followed by any well-known recrystallization annealing process. It may be beneficial for the processing subsequent to the beta quench to be performed at a temperature below about 900 degrees Celsius (e.g., about 500-800 degrees Celsius).

Referring to step S89, the cold-rolled alloy materials may be pressed to achieve a thick/thin dimension. The pressed alloy materials may be subjected to any well-known recovery (e.g., stress relief) annealing process. Alternatively, thick and thin pieces may be fabricated separately (e.g., rolling the alloy materials to form a thick piece and a thin piece) and welded together to achieve a welded material having a thick/thin dimension. A thick/thin dimension may be beneficial for purposes of reducing or minimizing the amount of material constituting a reactor component, because excess material may contribute to the absorption of neutrons. Pressing the cold-rolled jacket and slab to achieve a thick/thin dimension may provide better results compared to machining to achieve a thick/thin dimension, which may remove the cladding formed of the second alloy.

The finished multi-layer material may be deformed and welded to form a fuel channel. For example, two sheets of the finished material may be bent along the longitudinal direction to approximately 90 degree angles. The bent sheets may then be welded together to form an elongated fuel channel having a square-shaped cross-section. Because of the thick/thin dimension of the material, the central portion of the channel sidewalls may be relatively thin, while the portions of the sidewalls by the corners may be relatively thick.

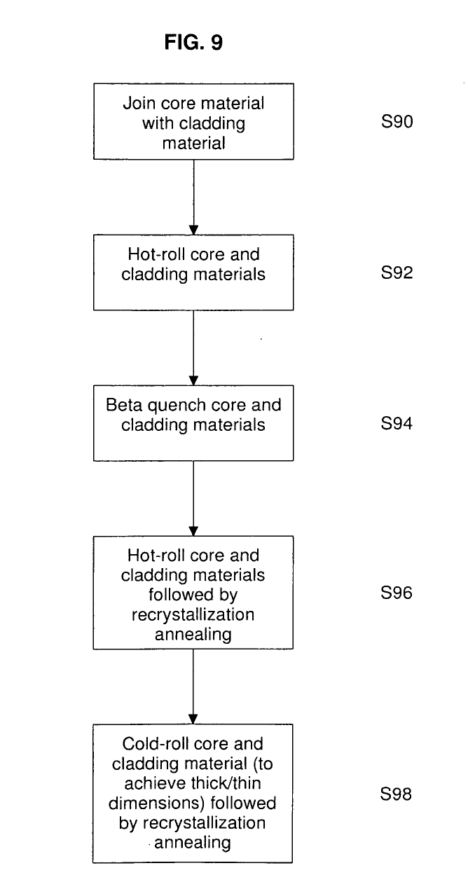

FIG. 9 is a flowchart of another method of fabricating a channel strip for a fuel channel according to example embodiments. As shown in step S90, a core material formed of a first alloy is joined to a cladding material formed of a second alloy. For example, a slab formed of a first alloy and a jacket formed of a second alloy may be provided, wherein the first and second alloys may have different compositions. The slab may be an alloy that is relatively resistant to irradiation growth and/or irradiation creep, while the jacket may be an alloy that is relatively resistant to hydrogen absorption and/or corrosion. For instance, the alloys may be as described above with reference to FIGS. 1-2. The slab may be inserted into the jacket, and a vacuum may be drawn to seal the slab in the jacket. Alternatively, it should be noted that the second alloy may also be in the form of a slab which is joined with the slab formed of the first alloy. For instance, the first alloy slab may be electron beam (e-beam) welded to the second alloy slab under a vacuum.

The joined alloy materials may be subjected to a first hot-roll process to achieve a first thickness (e.g., about 1 inch) in step S92. The first hot-roll process may be any well-known hot-roll process. Referring to step S94, the hot-rolled alloy materials may be beta quenched to increase resistance to corrosion and irradiation growth. The beta quenching may be achieved with any well-known beta quench process. For example, the hot-rolled alloy materials may be beta heat treated at a temperature greater than about 900 degrees Celsius followed by a beta quench.

Referring to step S96, the quenched alloy materials may also be subjected to a second hot-roll process to achieve a second thickness (e.g., less than 1 inch). The second hot-roll process may be any well-known hot-roll process. The second hot-roll process may be followed by any well-known recrystallization (RX) annealing process. Referring to step S98, the hot-rolled alloy materials may be subjected to a cold-roll process to achieve a third thickness having a thick/thin dimension. For example, the cold-roll process may be performed with a grooved roll to impress the thick/thin dimensions into the material. The cold-roll process may be followed by any well-known recrystallization annealing process. Alternatively, thick and thin pieces may be fabricated separately (e.g., rolling the alloy materials to form a thick piece and a thin piece) and welded together to achieve a welded material having a thick/thin dimension. It may be beneficial for the processing subsequent to the beta quench to be performed at a temperature below about 900 degrees Celsius (e.g., about 500-800 degrees Celsius).

The finished multi-layer material may be deformed and welded to form a fuel channel. For example, two sheets of the finished material may be bent along the longitudinal direction to approximately 90 degree angles. The bent sheets may then be welded together to form an elongated fuel channel having a square-shaped cross-section. Because of the thick/thin dimension of the material, the central portion of the channel sidewalls may be relatively thin, while the portions of the sidewalls by the corners may be relatively thick.

While example embodiments have been disclosed herein, it should be understood that other variations may be possible. Such variations are not to be regarded as a departure from the spirit and scope of example embodiments of the present disclosure, and all such modifications as would be obvious to one skilled in the art are intended to be included within the scope of the following claims.

1. A multi-layer material for a reactor component, comprising:
a core layer; and
at least one cladding layer metallurgically-bonded directly to the core layer,
the core layer and the at least one cladding layer having different compositions, the core layer having a higher weight percentage of niobium than the at least one cladding layer, the core layer being significantly more resistant to irradiation growth than the at least one cladding layer, and the at least one cladding layer having an increased resistance to hydrogen absorption relative to the core layer.

2. The material of claim 1, wherein the at least one cladding layer includes two cladding layers, the core layer being sandwiched between the two cladding layers.

3. The material of claim 1, wherein the core layer is formed of a first zirconium alloy containing niobium and the at least one cladding layer is formed of a second zirconium alloy containing tin, iron, and chromium.

4. The material of claim 3, wherein
the first alloy has a composition in weight percent of about 0.6-1.4% niobium, about 0.2-0.5% iron, and about 0.5-1.0% tin, with the balance being essentially zirconium, and
the second alloy has a composition in weight percent of about 0.4-2.0% tin, about 0.1-0.6% iron, and about 0.01-1.2% chromium, with the balance being essentially zirconium.

5. The material of claim 4, wherein
the first alloy has a composition in weight percent of about 1.0% niobium, about 0.35% iron, and about 1.0% tin, with the balance being essentially zirconium, and
the second alloy has a composition in weight percent of about 1.45% tin, about 0.21% iron, and about 0.1% chromium, with the balance being essentially zirconium.

6. The material of claim 4, wherein
the first alloy has a composition in weight percent of about 1.0% niobium, about 0.35% iron, and about 1.0% tin, with the balance being essentially zirconium, and
the second alloy has a composition in weight percent of about 0.5% tin, about 0.5% iron, and about 1.0% chromium, with the balance being essentially zirconium.

7. A fuel channel for a nuclear reactor, comprising:
an elongated and hollow body having a multi-layer structure, the multi-layer structure including,
a core layer; and
at least one cladding layer metallurgically-bonded to the core layer, the core layer and the at least one cladding layer having different compositions, the core layer having a higher weight percentage of niobium than the at least one cladding layer, the core layer being significantly more resistant to irradiation growth than the at least one cladding layer, and the at least one cladding layer having an increased resistance to hydrogen absorption relative to the core layer.

8. The fuel channel of claim 7, wherein the at least one cladding layer includes two cladding layers, the core layer being sandwiched between the two cladding layers.

9. The fuel channel of claim 7, wherein the core layer is formed of a first zirconium alloy containing niobium and the at least one cladding layer is formed of a second zirconium alloy containing tin, iron, and chromium.

10. The fuel channel of claim 9, wherein
the first alloy has a composition in weight percent of about 0.6-1.4% niobium, about 0.2-0.5% iron, and about 0.5-1.0% tin, with the balance being essentially zirconium, and
the second alloy has a composition in weight percent of about 0.4-2.0% tin, about 0.1-0.6% iron, and about 0.01-1.2% chromium, with the balance being essentially zirconium.

11. The fuel channel of claim 10, wherein
the first alloy has a composition in weight percent of about 1.0% niobium, about 0.35% iron, and about 1.0% tin, with the balance being essentially zirconium, and
the second alloy has a composition in weight percent of about 1.45% tin, about 0.21% iron, and about 0.1% chromium, with the balance being essentially zirconium.

12. The fuel channel of claim 10, wherein
the first alloy has a composition in weight percent of about 1.0% niobium, about 0.35% iron, and about 1.0% tin, with the balance being essentially zirconium, and
the second alloy has a composition in weight percent of about 0.5% tin, about 0.5% iron, and about 1.0% chromium, with the balance being essentially zirconium.

13. A method of fabricating a fuel channel for a nuclear reactor, comprising:
joining a core material with a cladding material, the core material and the cladding material having different compositions, the core material being significantly more resistant to irradiation growth than the cladding material, and the cladding material having an increased resistance to hydrogen absorption relative to the core material;
rolling the joined core and cladding materials; and
deforming the rolled core and cladding materials to form the fuel channel.

14. The method of claim 13, wherein the joining of the core and cladding materials comprises:
inserting the core material into the cladding material, the core material being a slab and the cladding material being a jacket designed to receive the slab, and
drawing a vacuum to seal the jacket containing the slab.

15. The method of claim 13, wherein the joining of the core and cladding materials includes electron beam welding the core material to the cladding material under a vacuum.

16. The method of claim 13, wherein the rolling of the joined core and cladding materials comprises:
performing a first hot-roll process on the core and cladding materials;
performing a beta quench process;
performing a second hot-roll process followed by annealing; and
performing a cold-roll process followed by annealing.

17. The method of claim 16, further comprising:
pressing the cold-rolled core and cladding materials to achieve a pressed material having a first portion with a first dimension and a second portion with a second dimension, the first dimension being relatively thick compared to the second dimension, and the second dimension being relatively thin compared to the first dimension; and
performing a recovery annealing process to relieve internal stresses in the pressed material.

18. The method of claim 16, wherein the cold-roll process is performed with a grooved roll to achieve a cold-rolled material having a first portion with a first dimension and a second portion with a second dimension, the first dimension being relatively thick compared to the second dimension, and the second dimension being relatively thin compared to the first dimension.

19. The method of claim 13, further comprising:
rolling the joined core and cladding materials to form a first rolled piece and a second rolled piece, the first rolled piece being relatively thick compared to the second rolled piece, and the second rolled piece being relatively thin compared to the first rolled piece; and
welding the first rolled piece to the second rolled piece to achieve a welded material having a first portion with a first dimension and a second portion with a second dimension, the first dimension being relatively thick compared to the second dimension, and the second dimension being relatively thin compared to the first dimension.
